(19) United States
(12) Patent Application Publication
(10) Pub. No.: US 2025/0293331 A1
(43) Pub. Date: Sep. 18, 2025

(54) METHOD FOR REGENERATING DETERIORATED SOLID ELECTROLYTE, SOLID ELECTROLYTE REGENERATED THEREBY, AND ALL-SOLID-STATE BATTERY COMPRISING THE REGENERATED SOLID ELECTROLYTE

(71) Applicant: UIF (University Industry Foundation), Yonsei University, Seoul (KR)

(72) Inventors: Yoon Seok JUNG, Seoul (KR); Yong Bae SONG, Seoul (KR); Bo Yeong JANG, Jeonbuk-do (KR)

(73) Assignee: UIF (University Industry Foundation), Yonsei University, Seoul (KR)

(21) Appl. No.: 19/081,001

(22) Filed: Mar. 17, 2025

(30) Foreign Application Priority Data
Mar. 18, 2024 (KR) 10-2024-0037272
Mar. 4, 2025 (KR) 10-2025-0027304

(51) Int. Cl. H01M 10/54; H01M 10/0562

(52) U.S. Cl. CPC H01M 10/54; H01M 10/0562; H01M 2220/20; H01M 2300/008

(57) ABSTRACT

The present disclosure relates to a method for regenerating a deteriorated solid electrolyte, a solid electrolyte regenerated thereby, and an all-solid-state battery including the regenerated solid electrolyte. The method for regenerating a deteriorated solid electrolyte of the present disclosure allows effective regeneration of a deteriorated solid electrolyte in short time through a simple process by effectively removing a moisture layer and byproducts adsorbed on the surface of the deteriorated solid electrolyte by radiating microwaves to the deteriorated solid electrolyte, and is advantageous in that the structure and ion conductivity retention rate and energy efficiency of the regenerated solid electrolyte are very superior as compared to a pristine solid electrolyte before deterioration. In particular, the solid electrolyte may have a high ion conductivity retention rate after passing through a wet-milling process.

### CROSS-REFERENCE TO RELATED APPLICATION

This application claims priority to Korean Patent Application Nos. 10-2024-0037272 and 10-2025-0027304, filed on Mar. 18, 2024 and Mar. 4, 2025, respectively, and all the benefits accruing therefrom under 35 U.S.C. § 119, the contents of which in its entirety are herein incorporated by reference.

### BACKGROUND

### 1. Field

The present disclosure relates to a method for regenerating a deteriorated solid electrolyte, a solid electrolyte regenerated thereby, and an all-solid-state battery including the regenerated solid electrolyte.

### 2. Description of the Related Art

An all-solid-state battery having the advantages of high stability and high energy density is actively being researched and developed as a next-generation secondary battery replacing the existing organic-based liquid electrolyte-based lithium-ion battery. The all-solid-state battery uses inorganic-based solid electrolytes instead of the organic-based liquid electrolyte. In particular, a halide-based solid electrolyte having superior ion conductivity and high oxidation stability and a sulfide-based solid electrolyte having high ion conductivity and superior physical properties are evaluated as key materials.

However, the halide-based solid electrolyte and sulfide-based solid electrolyte have deterioration problems such as decreased crystallinity, reduced ion conductivity and impurity formation when exposed to the atmosphere due to reaction with moisture, oxygen or other gases. In addition, the sulfide-based solid electrolyte may emit toxic hydrogen sulfide gas by reacting with moisture in the atmosphere.

For these reasons, the all-solid-state battery is prepared and studied in a glove box under inert gas atmosphere. However, for commercialization and mass production, it needs to be prepared and studied under an environment controlled below the dew point, e.g., in a dry room, which ensures the processability for mass production.

When the solid electrolyte is stored and used under a space and atmosphere controlled to a specific level, deterioration due to exposure to the atmosphere is inevitable. If the solid electrolyte is exposed to an atmosphere controlled to a specific level for a predetermined time, crystallinity and ion conductivity may decline, and this may affect the energy density, output characteristics, etc. of the assembled all-solid-state battery.

Therefore, technologies for recovering the crystallinity, ion conductivity, etc. of the solid electrolyte deteriorated due to storage and use in a specific space and atmosphere through specific process or treatment are being studied actively.

In the past, the crystallinity, ion conductivity, etc. of the solid electrolyte deteriorated after exposure to the atmosphere were restored mostly by heat-treating the solid electrolyte using heat applied from a heat source. However, the heat treatment process is time-consuming and consumes a lot of energy because it requires temperature above a certain level for complete restoration. That is to say, since the existing heat treatment method depends on the heat applied from a heat source, unlike microwave, it consumes a lot of energy because a larger amount of heat is necessary to achieve the temperature above a certain level.

Meanwhile, the commercially available solid electrolyte passes through a wet-milling process for control of uniform particle size. During the process, the solid electrolyte is exposed to organic materials, and some of the organic materials may remain on the surface of the solid electrolyte. If the solid electrolyte with the organic materials remaining on the surface thereof is regenerated by the existing heat treatment method, the electron conductivity of the solid electrolyte may increase due to the carbonization of the organic materials and, thus, complete restoration of the solid electrolyte may be difficult.

Therefore, for effective utilization of the solid electrolyte in the all-solid-state battery, the development of a new technology that can suppress the carbonization of remaining organic materials while effectively restoring the crystal structure, ion conductivity, etc. of the solid electrolyte which have been deteriorated to specific levels under a specific atmosphere is required.

### REFERENCES OF THE RELATED ART

### Patent Documents

(Patent document 1) Japanese Patent Publication No. 2014-216217.

### SUMMARY

The present disclosure is directed to providing a method for regenerating a deteriorated solid electrolyte, which allows effective regeneration of a deteriorated solid electrolyte in short time through a simple process and provides superior structure and ion conductivity retention rate as compared to a pristine solid electrolyte before deterioration.

The present disclosure is also directed to providing a regenerated solid electrolyte with superior structure and ion conductivity retention rate.

The present disclosure is also directed to providing an all-solid-state battery, which includes the solid electrolyte according to the present disclosure.

The present disclosure is also directed to providing a device including the all-solid-state battery according to the present disclosure.

The present disclosure is also directed to providing an electrical device including the all-solid-state battery according to the present disclosure.

The present disclosure provides a method for regenerating a solid electrolyte, which includes a step of obtaining a regenerated solid electrolyte by radiating microwaves to a deteriorated solid electrolyte together with a moisture absorbent under vacuum or inert gas atmosphere.

The present disclosure also provides a regenerated solid electrolyte with an ion conductivity retention rate of 30 to 100%, wherein the regenerated solid electrolyte is a solid electrolyte obtained by radiating microwaves to a deteriorated solid electrolyte together with a moisture absorbent under vacuum or inert gas atmosphere.

The present disclosure also provides an all-solid-state battery including: a positive electrode; a negative electrode; and the solid electrolyte according to the present disclosure provided between the positive electrode and the negative electrode.

The present disclosure also provides a device including the all-solid-state battery according to the present disclosure, wherein the device is any one selected from a mobile device, a communication device, a transportation device and an energy storage device.

The present disclosure also provides an electrical device including the all-solid-state battery according to the present disclosure, wherein the electrical device is any one selected from an electric vehicle, a hybrid electric vehicle, a plug-in hybrid electric vehicle and a power storage device.

The method for regenerating a deteriorated solid electrolyte of the present disclosure allows effective regeneration of a deteriorated solid electrolyte in short time through a simple process by effectively removing a moisture layer and byproducts adsorbed on the surface of the deteriorated solid electrolyte by radiating microwaves to the deteriorated solid electrolyte, and is advantageous in that the structure and ion conductivity retention rate and energy efficiency of the regenerated solid electrolyte are very superior as compared to a pristine solid electrolyte before deterioration. In particular, the solid electrolyte may have a high ion conductivity retention rate after passing through a wet-milling process.

The effects of the present disclosure are not limited to those described above. It is to be understood that the effects of the present disclosure include all the effects that can be inferred from the following description.

### BRIEF DESCRIPTION OF THE DRAWINGS

FIG. 1 schematically describes a method for regenerating a deteriorated solid electrolyte according to the present disclosure.

FIG. 2 shows the result of DRIFTS analysis for a regenerated solid electrolyte of Example 1 according to the present disclosure.

FIG. 3 shows the result of DRIFTS analysis for a regenerated solid electrolyte of Example 2.

FIG. 4 shows the result of XRD analysis for a regenerated solid electrolyte of Example 2.

FIG. 5 shows the charge-discharge performance of an all-solid-state battery including a regenerated solid electrolyte of Example 2.

FIG. 6 shows the discharge capacity of an all-solid-state battery including a regenerated solid electrolyte of Example 2 depending on cycle number.

### DETAILED DESCRIPTION

The present disclosure relates to a method for regenerating a deteriorated solid electrolyte, a solid electrolyte regenerated thereby, and an all-solid-state battery including the regenerated solid electrolyte.

As described above, in the past, the structure, ion conductivity, etc. of a solid electrolyte deteriorated after exposure to the atmosphere were restored mostly by heat-treating the solid electrolyte using heat applied from a heat source. However, such a heat treatment process is time-consuming and consumes a lot of energy because it requires temperature above a certain level for complete restoration. In addition, when the solid electrolyte passes through a wet-milling process for control of uniform particle size, organic materials may remain on the surface of the solid electrolyte due to exposure to a solvent. If the solid electrolyte with the organic materials remaining on the surface thereof is regenerated by the existing heat treatment method, the electron conductivity of the solid electrolyte may increase due to the carbonization of the remaining organic materials.

The present disclosure is advantageous in that it allows effective regeneration of a deteriorated solid electrolyte in short time through a simple process by effectively removing a moisture layer and byproducts adsorbed on the surface of the deteriorated solid electrolyte by radiating microwaves to the deteriorated solid electrolyte, and the structure and ion conductivity retention rate and energy efficiency of the regenerated solid electrolyte are very superior as compared to a pristine solid electrolyte before deterioration. In particular, the solid electrolyte may have a high ion conductivity retention rate after passing through a wet-milling process.

Specifically, the present disclosure provides a method for regenerating a deteriorated solid electrolyte, which includes a step of obtaining a regenerated solid electrolyte by radiating microwaves to a deteriorated solid electrolyte together with a moisture absorbent under vacuum or inert gas atmosphere.

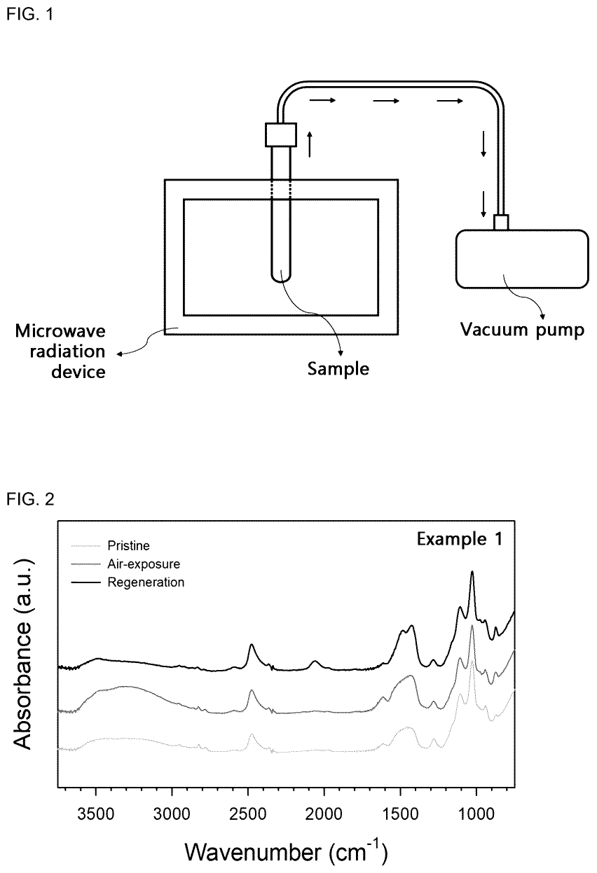

FIG. 1 schematically describes the method for regenerating a deteriorated solid electrolyte according to the present disclosure. Referring to FIG. 1, after placing a deteriorated solid electrolyte in a microwave radiation device, a regenerated solid electrolyte may be obtained by radiating microwaves together with a moisture absorbent under vacuum or inert gas atmosphere. At this time, vacuum atmosphere may be formed inside the microwave radiation device by a vacuum pump.

The solid electrolyte may be one prepared by a solid-phase synthesis method or a liquid-phase synthesis method, or a solid electrolyte that has been wet-milled after preparation by a solid-phase synthesis method or a liquid-phase synthesis method. Specifically, the solid electrolyte may be a solid electrolyte that has been wet-milled after preparation by a solid-phase synthesis method or a liquid-phase synthesis method. Most specifically, it may be a solid electrolyte that has been wet-milled after preparation by a solid-phase synthesis method.

The solid-phase synthesis method includes mechanical milling, heat treatment, melt-quenching, etc., although not being limited thereto.

The liquid-phase synthesis method includes a method of synthesizing a solid electrolyte by dispersing a solid electrolyte raw material in a solvent, a method of synthesizing a solid electrolyte in a homogeneous solution, etc., although not being limited thereto.

In particular, when a solid electrolyte synthesized by a solid-phase synthesis method is wet-milled, the solvent remaining on the surface of the solid electrolyte after the post-treatment process such as wet-milling during the regeneration of the deteriorated solid electrolyte by the existing heat treatment method may be undesirably carbonized at high temperature. This problem can be solved by radiating microwaves during the regeneration.

The solid electrolyte may be one or more selected from a group consisting of an oxide-based solid electrolyte, a borohydride-based solid electrolyte, a sulfide-based solid electrolyte and a halide-based solid electrolyte, specifically a sulfide-based solid electrolyte or a halide-based solid electrolyte, most specifically a sulfide-based solid electrolyte.

As specific examples of the solid electrolyte, the oxide-based solid electrolyte may be one or more selected from a group consisting of LiₓLa_{y}TiO₃ (x is 0.3 to 0.7, and y is 0.3 to 0.7), LiₓLa_{y}Zr_{z}MₘOₙ (M is Al, Mg, Ca, Sr, V, Nb, Ta, Ti, Ge, In or Sn, x satisfies 5≤x≤10, y satisfies 1≤y≤4, z satisfies 1≤z≤4, m satisfies 0≤m≤2, and n satisfies 5≤n≤20) and LiₓB_{y}M_{z}Oₙ (M is C, S, Al, Si, Ga, Ge, In or Sn, x satisfies 0≤x≤5, y satisfies 0≤y≤1, z satisfies 0≤z≤1, and n satisfies 0≤n≤6), although not being limited thereto.

The borohydride-based solid electrolyte may be LiBH₄.

The sulfide-based solid electrolyte may be one or more selected from a group consisting of Li₂S-P₂S₅, Li₂S-P₂S₅-LiX (X is F, Cl, Br, I or O), Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B2S₃, Li₂S-P₂S₅-ZₘSₙ (1≤m≤10, 1≤n≤10, and Z is Ge, Zn or Ga), Li₂S-GeS₂, Li₂S-SiS₂-Li₃PO4, Li₂S-SiS₂-LiₚMO_{q} (1≤p≤10, 1≤q≤10, and M is P, Si, Ge, B, Al, Ga or In), thio-LISICONS, Li₁₀GeP₂S₁₂, Li_{9.54}Si_{1.74}P_{1.44}S_{11.7}Cl_{0.3}, Li₁₋ₓPS₆₋ₓXₓ (LPSX; X is Cl, Br or I, and x satisfies 0≤x≤2), and Li₁₂₋ₘ₋ₓ⁺(M^{m+}Y₄²⁻)Y₂₋ₓ²⁻Xₓ⁻(M is Si, Ge, Sn, P or As, Y is O, S, Se or Te, X is Cl, Br or I, and x satisfies 0≤x≤2), specifically Li₆PS₅Cl.

The halide-based solid electrolyte may be LiₐM_{b}X_{c} (M is one or more selected from Mg, Ca, Zn, Cd, Cu, Sc, Y, B, Al, Ga, In, Ln, La, Ce, Pr, Nd, Pm, Sm, Eu, Gd, Tb, Dy, Ho, Er, Yb, Lu, Ti, Zr, Hf, Nb, Ta, Mo, W, Sb, Si, Ge, Sn, V, Cr, Mn, Fe, Co and Ni, X is one or more selected from F, Cl, Br and I, a satisfies 0.01≤a≤10, b satisfies 0.01≤b≤10, and c satisfies 0.01≤c≤10) and LiₐM_{b}N_{c}X_{d} (M is one or more selected from Mg, Ca, Zn, Cd, Cu, Sc, Y, B, Al, Ga, In, Ln, La, Ce, Pr, Nd, Pm, Sm, Eu, Gd, Tb, Dy, Ho, Er, Yb, Lu, Ti, Zr, Hf, Nb, Ta, Mo, W, Sb, Si, Ge, Sn, V, Cr, Mn, Fe, Co and Ni, N is one or more selected from O, S and Se, X is one or more selected from F, Cl, Br and I, a satisfies 0.01≤a≤10, b satisfies 0.01≤b≤10, c satisfies 0.01≤c≤10, d satisfies 0.01≤d≤10), specifically Li₃InCl₆.

In general, when a solid electrolyte is exposed to the atmosphere or stored in an atmosphere where moisture is controlled to a specific level, it is partially deteriorated by reacting with moisture, oxygen, other gases, etc., leading to decline in crystallinity, decrease in ion conductivity and impurity formation. In the present disclosure, the deteriorated solid electrolyte may be a solid electrolyte which has been deterioration by being exposed to an atmosphere with a dew point of −80 to −30° C. for 4 hours or longer, specifically to an atmosphere with a dew point of −50 to −35° C. for 5 hours or longer, most specifically to an atmosphere with a dew point of −45 to −38° C. for 6 hours or longer. The deteriorated solid electrolyte may have an ion conductivity retention rate of 50 to 60%.

The microwave radiation may be performed under vacuum or inert gas atmosphere, specifically under vacuum atmosphere.

Particularly, the vacuum atmosphere may be a static vacuum atmosphere. The static vacuum state is advantageous in that, since the vacuum atmosphere of a specific level is maintained in a closed system, energy consumption is less as compared to a dynamic vacuum atmosphere or a gas flow system.

But, when microwaves are radiated under static vacuum atmosphere, a moisture absorbent may be used to effectively remove moisture removed from the deteriorated solid electrolyte, which exists in the closed system.

The moisture absorbent may be a moisture scavenger, and specific examples may include one or more selected from a group consisting of P₂O₅, silica, alumina and zeolite, specifically P₂O₅.

The inert gas may be one or more selected from a group consisting of argon (Ar), helium (He), neon (Ne), krypton (Kr) and xenon (Xe), although not being limited thereto. Specifically, the inert gas may be argon (Ar).

In general, moisture is adsorbed when a solid electrolyte is exposed to the atmosphere. The adsorbed moisture may be removed by the heat generated by radiating microwaves. At this time, if organic materials remain on the solid electrolyte, sufficient heat may be generated by the remaining organic materials, and the hydration layer, Li₂CO₃, etc. may be removed enough. If the organic materials do not remain on the solid electrolyte, Li₂CO₃ may not be removed completely due to insufficient heat generation, and electron conductivity may increase.

For complete removal of the moisture adsorbed on the solid electrolyte, wavelength and time are of importance during the microwave radiation. Specifically, the microwave radiation may be performed at a wavelength of 100 to 900 W for 5 to 30 minutes, specifically at a wavelength of 180 to 800 W for 8 to 13 minutes, most specifically at a wavelength of 500 to 800 W for 9 to 11 minutes.

If the wavelength during the microwave radiation is below 100 W or if the radiation time is shorter than 5 minutes, the structure and ion conductivity retention rate may be unsatisfactory. And, even if the wavelength exceeds 900 W or the radiation time exceeds 30 minutes, further improvement of the structure and ion conductivity retention rate cannot be expected.

The microwave radiation may be performed by directly radiating microwaves to the deteriorated solid electrolyte or by radiating microwaves after placing the deteriorated solid electrolyte in a microwave absorber. Specifically, microwaves may be radiated directly to the deteriorated solid electrolyte.

When microwaves are radiated directly to the deteriorated solid electrolyte, the moisture layer and other byproducts adsorbed to the surface of the deteriorated solid electrolyte may be removed more effectively since the microwaves are delivered directly, and the deteriorated solid electrolyte may be regenerated effectively in short time as compared to the existing restoration process through heat treatment.

In addition, when microwaves are radiated after placing the deteriorated solid electrolyte inside the microwave absorber, it is advantageous in that the remaining solvent adsorbed on the surface of the solid electrolyte is not carbonized at all since the deteriorated solid electrolyte is regenerated by the heat generated by the microwave absorber.

The microwave absorber may generate heat quickly during the microwave radiation because it has a high dielectric constant. Specific examples of the microwave absorber may include a carbon crucible, a carbon powder or a mixture thereof. Specifically, it may be a carbon crucible.

The regenerated solid electrolyte may have an ion conductivity retention rate of 30 to 100%, specifically 80 to 100%, more specifically 89 to 100%, most specifically 95 to 100%.

In particular, although it was not explicitly described in the examples, comparative examples, etc., the density and crystal structure restoration ratio of a regenerated solid electrolyte obtained by the method for regenerating a deteriorated solid electrolyte according to the present disclosure were evaluated while varying the following 6 conditions.

As a result, when all of the following conditions were satisfied, the crystal growth of the solid electrolyte was recovered quickly and, therefore, the density was recovered completely to a level comparable or similar to that of the pristine solid electrolyte before deterioration and the solid electrolyte exhibited a high crystal structure restoration ratio of 98% or higher as compared to other conditions and numerical ranges. In addition, the electron conductivity was maintained low. It is because the carbonization of the solvent remaining after the process was prevented by the heat treatment process.

\textcircled{1} The solid electrolyte is a sulfide-based solid electrolyte that has been wet-milled after being synthesized by a solid-phase synthesis method. \textcircled{2} The deteriorated solid electrolyte is a solid electrolyte that has been deteriorated by being exposed to an atmosphere with a dew point of −50 to −35° C. for 5 hours or longer. \textcircled{3}

The moisture absorbent is P₂O₅. \textcircled{4} The microwave radiation is performed by radiating microwaves directly to the deteriorated solid electrolyte. \textcircled{5} The microwave radiation is performed under vacuum atmosphere at a wavelength of 500 to 800 W for 9 to 11 minutes. \textcircled{6} The regenerated solid electrolyte has an ion conductivity retention rate of 95 to 100%.

If any of the 6 condition was not satisfied, the density of the solid electrolyte was decreased significantly as compared to the solid electrolyte before deterioration, and the solid electrolyte also exhibited a low crystal structure restoration ratio of 60% or lower. In addition, the energy density and output characteristics of the all-solid-state battery declined due to the increase in electron conductivity caused by the carbonization of the solvent remaining during heat treatment.

The present disclosure also provides a regenerated solid electrolyte with an ion conductivity retention rate of 30 to 100%, wherein the regenerated solid electrolyte is a solid electrolyte obtained by radiating microwaves to a deteriorated solid electrolyte together with a moisture absorbent under vacuum or inert gas atmosphere.

The present disclosure also provides an all-solid-state battery including: a positive electrode; a negative electrode; and the solid electrolyte according to the present disclosure provided between the positive electrode and the negative electrode.

The present disclosure also provides a device including the all-solid-state battery according to the present disclosure, wherein the device is any one selected from a mobile device, a communication device, a transportation device and an energy storage device.

The mobile device may be a mobile phone, a notebook computer, a digital camera, etc., although not being limited thereto.

The present disclosure also provides an electrical device including the all-solid-state battery according to the present disclosure, wherein the electrical device is one selected from an electric vehicle, a hybrid electric vehicle, a plug-in hybrid electric vehicle and a power storage device.

Hereinafter, the present disclosure will be described more specifically through examples. However, the present disclosure is not limited by the following examples.

### Example 1: Regeneration of Solid Electrolyte

A sulfide-based solid electrolyte Li₆PS₅Cl prepared by solid-phase synthesis, having an ion conductivity of 3.4 mS/cm at 30° C., was used. The Li₆PS₅Cl solid electrolyte was exposed to an atmosphere controlled to a dew point of −40° C. for 6 hours. The solid electrolyte deteriorated through the exposure to the atmosphere was placed under vacuum atmosphere together with P₂O₅ as a moisture scavenger, with physical separation, and a regenerated solid electrolyte was prepared by radiating microwaves directly to the solid electrolyte at 800 W for 10 minutes.

### Example 2: Regeneration of Solid Electrolyte

A sulfide-based solid electrolyte Li₆PS₅Cl prepared by solid-phase synthesis, having an ion conductivity of 3.4 mS/cm at 30° C., was used. For control of uniform particle size, the Li₆PS₅Cl solid electrolyte was wet-milled in a p-xylene solvent. Then, in order to remove the p-xylene solvent, the solid electrolyte was dried under vacuum atmosphere at 100° C. for 6 hours. The dried solid electrolyte was exposed to an atmosphere controlled to a dew point of −40° C. for 6 hours. The solid electrolyte deteriorated through the exposure to the atmosphere was placed under vacuum atmosphere together with P₂O₅, with physical separation, and a regenerated solid electrolyte was prepared by radiating microwaves directly to the solid electrolyte at 800 W for 10 minutes.

### Example 3: Regeneration of Solid Electrolyte

A sulfide-based solid electrolyte Li₆PS₅Cl prepared by solid-phase synthesis, having an ion conductivity of 3.4 mS/cm at 30° C., was used. The Li₆PS₅Cl solid electrolyte was exposed to an atmosphere controlled to a dew point of −40° C. for 6 hours. The solid electrolyte deteriorated through the exposure to the atmosphere was placed under vacuum atmosphere together with P₂O₅, with physical separation, and a regenerated solid electrolyte was prepared by radiating microwaves to the solid electrolyte inside a carbon crucible at 180 W for 10 minutes.

### Example 4: Regeneration of Solid Electrolyte

A sulfide-based solid electrolyte Li₆PS₅Cl prepared by solid-phase synthesis, having an ion conductivity of 3.4 mS/cm at 30° C., was used. For control of uniform particle size, the Li₆PS₅Cl solid electrolyte was wet-milled in a p-xylene solvent. Then, in order to remove the p-xylene solvent, the solid electrolyte was dried under vacuum atmosphere at 100° C. for 6 hours. The dried solid electrolyte was exposed to an atmosphere controlled to a dew point of −40° C. for 6 hours. The solid electrolyte deteriorated through the exposure to the atmosphere was placed under vacuum atmosphere together with P₂O₅, with physical separation, and a regenerated solid electrolyte was prepared by radiating microwaves to the solid electrolyte inside a carbon crucible at 180 W for 10 minutes.

### Example 5: Regeneration of solid electrolyte

A sulfide-based solid electrolyte LisInCle prepared by solid-phase synthesis, having an ion conductivity of 1.4 mS/cm at 30° C., was used. The Li₃InCl₆ solid electrolyte was exposed to an atmosphere controlled to a dew point of −30° C. for 12 hours. A regenerated solid electrolyte was prepared by radiating microwaves directly to the solid electrolyte at 800 W for 10 minutes.

### Comparative Example 1: Regeneration of solid electrolyte

A sulfide-based solid electrolyte Li₆PS₅Cl prepared by solid-phase synthesis, having an ion conductivity of 3.4 mS/cm, was used. The Li₆PS₅Cl solid electrolyte was exposed to an atmosphere controlled to a dew point of −40° C. for 6 hours. A regenerated solid electrolyte was prepared by heat-treating the solid electrolyte deteriorated through the exposure to the atmosphere under vacuum atmosphere at 550° C. for 8 hours.

### Comparative Example 2: Regeneration of Solid Electrolyte

A sulfide-based solid electrolyte Li₆PS₅Cl prepared by solid-phase synthesis, having an ion conductivity of 3.4 mS/cm at 30° C., was used. For control of uniform particle size, the Li₆PS₅Cl solid electrolyte was wet-milled in a p-xylene solvent. Then, in order to remove the p-xylene solvent, the solid electrolyte was dried under vacuum atmosphere of 100 mTorr or lower at 100° C. for 6 hours. The dried solid electrolyte was exposed to an atmosphere controlled to a dew point of −40° C. for 6 hours. A regenerated solid electrolyte was prepared by heat-treating the solid electrolyte deteriorated through the exposure to the atmosphere under vacuum atmosphere at 550° C. for 8 hours.

### Test Example 1: Analysis of Ion Conductivity

For the solid electrolytes prepared in Examples 1 to 5 and Comparative Examples 1 and 2, the ion conductivity and electron conductivity of the pristine solid electrolyte, the ion conductivity after exposure to the atmosphere, and the ion conductivity, ion conductivity retention rate and electron conductivity of the regenerated solid electrolyte were analyzed. The result is shown in Table 1.

TABLE 1

| | | | | Air | | | |
|---|---|---|---|---|---|---|---|
| | | Pristine | | exposure | Regeneration | | |
| | | Ion | Electron | Ion | Ion | Ion | Electron |
| | Solid | conductivity | conductivity | conductivity | conductivity | conductivity | conductivity |
| | electrolyte | (mS cm⁻¹) | (S cm⁻¹) | (mS cm⁻¹) | (mS cm⁻¹) | retention rate | (S cm⁻¹) |
| Comp. | Li₆PS₅Cl | 3.4 | 1.1 × 10⁻⁹ | 1.1 | 3.9 | 114% | 1.3 × 10⁻⁹ |
| Ex. 1 | | | | | | | |
| Comp. | | 3.0 | 1.7 × 10⁻⁹ | 1.5 | 2.8 | 92% | 6.6 × 10⁻⁵ |
| Ex. 2 | | | | | | | |
| Ex. 1 | | 3.4 | 1.1 × 10⁻⁹ | 2.5 | 1.5 | 45% | 1.1 × 10⁻⁹ |
| Ex. 2 | | 3.3 | 1.8 × 10⁻⁹ | 2.1 | 3.3 | 98% | 2.8 × 10⁻⁸ |
| Ex. 3 | | 3.4 | 1.1 × 10⁻⁹ | 2.4 | 3.1 | 90% | 1.1 × 10⁻⁹ |
| Ex. 4 | | 3.3 | 1.8 × 10⁻⁹ | 2.1 | 3.0 | 89% | 5.2 × 10⁻⁹ |
| Ex. 5 | Li₃InCl₆ | 1.4 | — | 0.3 | 0.9 | 59% | — |

As seen from Table 1, for Comparative Example 1 wherein heat treatment was performed at high temperature, ion conductivity was improved, but energy consumption was large due to the high temperature and process time was long. For Comparative Example 2, ion conductivity was recovered to 92% after heat treatment, but the carbonization product of Li₂CO₃ was formed due to the carbonization of the solvent remaining on the surface of the solid electrolyte, and electron conductivity was increased from 1.7×10⁻⁹ S/cm to 6.6×10⁻⁵ S/cm because of the carbonization product.

In contrast, for Example 1 wherein microwaves were radiated directly, unlike Comparative Example 1, enough heat was not generated due to the absence of remaining organic materials when the microwaves were radiated and, therefore, ion conductivity was decreased since the components that reduce ion conductivity such as Li₂CO₃, H₂O, etc. were not removed enough but located at the grain boundary. In addition, due to the absence of remaining organic materials, carbonization did not occur on the surface of the solid electrolyte and electron conductivity did not change significantly.

And, for Example 2, unlike Comparative Example 2, electron conductivity did not change significantly, from 1.8×10⁻⁹ S cm⁻¹ to 2.8×10⁻⁸ S cm⁻¹, after the microwave radiation and carbonization did not occur during the microwave radiation. lon conductivity was recovered to a level similar to that before the deterioration, and the highest ion conductivity retention rate was exhibited.

And, for Example 3, ion conductivity was recovered to a level similar to that before the deterioration, and electron conductivity was also maintained at the same level, confirming that carbonization did not occur on the surface. This suggests that ion conductivity retention rate was increased because sufficient heat was supplied as the microwave absorber such as a carbon crucible was used.

And, for Example 4, ion conductivity was recovered to a level similar to that before the deterioration and, unlike Comparative Example 2, electron conductivity did not change significantly after the microwave radiation, from 1.8×10⁻⁹ S cm⁻¹ to 5.2×10⁻⁹ S/cm, confirming that carbonization did not occur during the microwave radiation.

And, for Example 5, wherein the LisInCle halide-based solid electrolyte was used, different regeneration result was exhibited because of different mechanism from that of the Li₆PS₅Cl sulfide-based solid electrolyte in the comparative examples and other examples. But, it exhibited an ion conductivity retention rate of 59%, confirming that the halide-based solid electrolyte can be regenerated.

### Test Example 2: DRIFTS Analysis of Solid Electrolyte

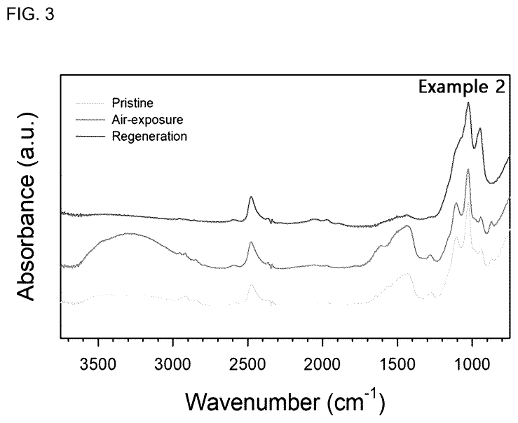

For the solid electrolytes prepared in Examples 1 and 2, the formation of a hydration layer and carbonization products was investigated for the solid electrolyte exposed to the atmosphere and the regenerated solid electrolyte by DRIFTS (diffuse reflectance infrared Fourier transform spectroscopy) analysis. The result is shown in FIGS. 2 and 3.

FIG. 2 shows the result of the DRIFTS analysis for the regenerated solid electrolyte of Example 1 according to the present disclosure.

As seen from FIG. 2, a hydration layer was formed on the surface of the solid electrolyte of Example 1 exposed to the atmosphere, with the intensity of the peaks at 1615 cm⁻¹ and 3000 to 3600 cm⁻¹ increased. In addition, the formation of Li₂CO₃ was confirmed, with the intensity of the peaks at 1480, 1420 and 860 cm⁻¹ increased.

In addition, the regenerated solid electrolyte of Example 1 showed decreased intensity of the peaks at 1615 cm⁻¹ and 3000 to 3600 cm⁻¹ after the microwave radiation as compared to the solid electrolyte before the regeneration, suggesting that the surface hydration layer was removed. However, the intensity of the peaks at 1480, 1420 and 860 cm⁻¹ was maintained, suggesting that Li₂CO₃ remained. This indicates that, for Example 1 wherein the solid electrolyte contains remaining organic materials, Li₂CO₃ remains without being removed due to insufficient heat generation.

FIG. 3 shows the result of DRIFTS analysis for the regenerated solid electrolyte of Example 2.

As seen from FIG. 3, the solid electrolyte of Example 2 exposed to the atmosphere showed increased intensity of the peaks at 1615 cm⁻¹ and 3000 to 3600 cm⁻¹, which confirms the formation of a hydration layer on the surface. In addition, the increased intensity of the peaks at 1480, 1420 and 860 cm⁻¹ confirms the formation of Li₂CO₃.

In addition, the regenerated solid electrolyte of Example 2 showed, after microwave radiation, decreased intensity of the peaks at 1615 cm⁻¹ and 3000 to 3600 cm⁻¹ as compared to the solid electrolyte before the regeneration, suggesting that the hydration layer on the surface was removed. In addition, the decreased intensity of the peaks at 1480, 1420 and 860 cm⁻¹ wavelength confirms that Li₂CO₃ was removed.

### Test Example 3: XRD Analysis of Solid Electrolyte

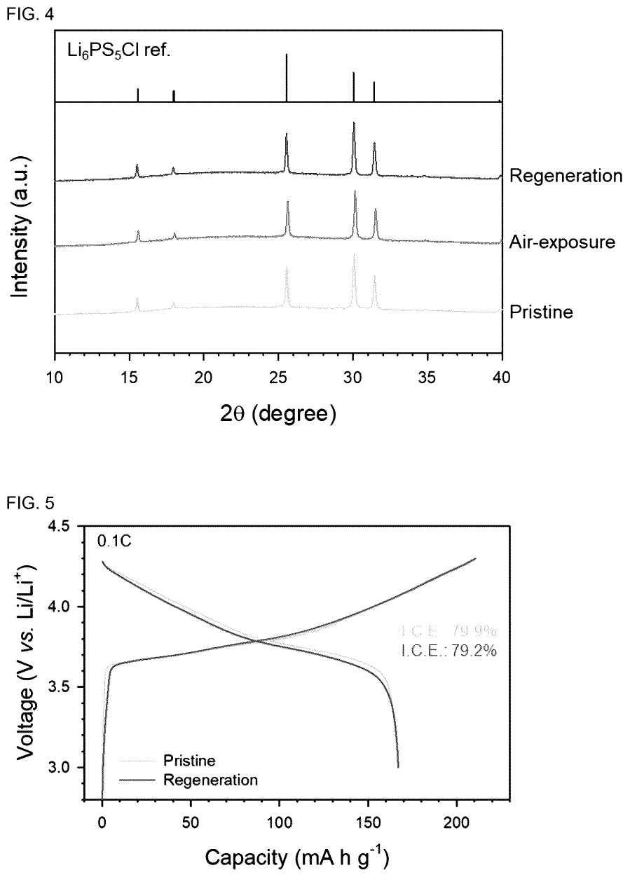

For the regenerated solid electrolyte obtained in Example 2, XRD analysis was performed to investigate the crystal structure of the solid electrolyte exposed to the atmosphere and the regenerated solid electrolyte. The result is shown in FIG. 4.

FIG. 4 shows the result of XRD analysis for the regenerated solid electrolyte of Example 2.

Referring to FIG. 4, for Example 2, the structure was maintained after the regeneration (Regeneration) as compared to the solid electrolyte before deterioration (Pristine), confirming that the crystal structure of the solid electrolyte was not impaired during the microwave radiation.

### Test Example 4: Analysis of Charge-Discharge Performance of All-Solid-State Battery Including Solid Electrolyte

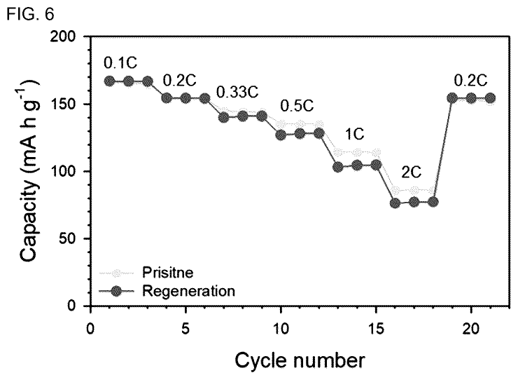

An NCM/Li-In half-cell was prepared according to a common method by using the regenerated solid electrolyte of Example 2 in a cathode. A positive electrode was prepared by mixing LiNi_{0.70}Co_{0.15}Mn_{0.15}O₂: solid electrolyte: Super C at a weight ratio of 70:30: 3. The charge-discharge characteristics of the prepared all-solid half-cell were evaluated at 30° C. under the condition of 0.1 C, 0.2 C, 0.5 C, 1 C and 2 C. The result is shown in FIGS. 5 and 6.

FIG. 5 shows the charge-discharge performance of the all-solid-state battery including the regenerated solid electrolyte of Example 2.

FIG. 6 shows the discharge capacity of the all-solid-state battery including the regenerated solid electrolyte of Example 2 depending on cycle number.

Referring to FIGS. 5 and 6, the all-solid-state battery including the regenerated solid electrolyte of Example 2 showed charge-discharge performance and discharge capacity similar to those of the all-solid-state battery including the solid electrolyte before deterioration. Through this, it can be seen that not only ion conductivity but also electrochemical performance is also recovered to a similar level.

What is claimed is:

1. A method for regenerating a deteriorated solid electrolyte, comprising a step of obtaining a regenerated solid electrolyte by radiating microwaves to a deteriorated solid electrolyte under vacuum or inert gas atmosphere together with a moisture absorbent.

2. The method for regenerating a deteriorated solid electrolyte according to claim 1, wherein the solid electrolyte is prepared by a solid-phase synthesis method or a liquid-phase synthesis method, or a solid electrolyte synthesized by a solid-phase synthesis method or a liquid-phase synthesis method that has been wet-milled.

3. The method for regenerating a deteriorated solid electrolyte according to claim 1, wherein the solid electrolyte is one or more selected from a group consisting of an oxide-based solid electrolyte, a borohydride-based solid electrolyte, a sulfide-based solid electrolyte and a halide-based solid electrolyte.

4. The method for regenerating a deteriorated solid electrolyte according to claim 1, wherein the deteriorated solid electrolyte is one obtained by deteriorating the solid electrolyte by exposing to an atmosphere with a dew point of −80 to −30° C. for 4 to 10 hours.

5. The method for regenerating a deteriorated solid electrolyte according to claim 1, wherein the moisture absorbent is one or more selected from a group consisting of P₂O₅, silica, alumina and zeolite.

6. The method for regenerating a deteriorated solid electrolyte according to claim 1, wherein the microwave radiation is performed at a wavelength of 100 to 900 W for 5 to 30 minutes.

7. The method for regenerating a deteriorated solid electrolyte according to claim 1, wherein the microwave radiation is performed by radiating microwaves directly to the deteriorated solid electrolyte, or by radiating microwaves after placing the deteriorated solid electrolyte in a microwave absorber.

8. The method for regenerating a deteriorated solid electrolyte according to claim 7, wherein the microwave absorber is a carbon crucible, a carbon powder or a mixture thereof.

9. The method for regenerating a deteriorated solid electrolyte according to claim 7, wherein, in the step of obtaining the regenerated solid electrolyte, the deteriorated solid electrolyte is regenerated by the heat generated by the microwave absorber.

10. The method for regenerating a deteriorated solid electrolyte according to claim 1, wherein the regenerated solid electrolyte has an ion conductivity retention rate of 30 to 100%.

11. The method for regenerating a deteriorated solid electrolyte according to claim 1, wherein
the solid electrolyte is a sulfide-based solid electrolyte synthesized by a solid-phase synthesis method that has been wet-milled,
the deteriorated solid electrolyte is a solid electrolyte deteriorated by being exposed to an atmosphere with a dew point of −50 to −35° C. for 5 to 7 hours,
the moisture absorbent is P₂O₅,
the microwave radiation is performed by radiating microwaves directly to the deteriorated solid electrolyte,
the microwave radiation is performed under vacuum atmosphere at a wavelength of 500 to 800 W for 9 to 11 minutes, and
the regenerated solid electrolyte has an ion conductivity retention rate of 95 to 100%.

12. A regenerated solid electrolyte having an ion conductivity retention rate of 30 to 100%, wherein the regenerated solid electrolyte is a solid electrolyte obtained by radiating microwaves to a deteriorated solid electrolyte together with a moisture absorbent under vacuum or inert gas atmosphere.

13. An all-solid-state battery comprising:
a positive electrode;
a negative electrode; and
the solid electrolyte according to claim 12 provided between the positive electrode and the negative electrode.

14. A device comprising the all-solid-state battery according to claim 13, wherein the device is any one selected from a mobile device, a communication device, a transportation device and an energy storage device.

15. An electrical device comprising the all-solid-state battery according to claim 13 wherein the electrical device is any one selected from an electric vehicle, a hybrid electric vehicle, a plug-in hybrid electric vehicle and a power storage device.
